(19) United States
(12) Patent Application Publication
(10) Pub. No.: US 2024/0406746 A1
(43) Pub. Date: Dec. 5, 2024

(54) Spectrum Controller to Assist Allocation of Spectrum and Guaranteeing the Quality of Service (QOS) Within the Enterprise Network

(71) Applicant: Celona, Inc., Campbell, CA (US)

(72) Inventors: Manan Shah, Campbell, CA (US); Vanlin Sathya, Campbell, CA (US); Srinivasan Balasubramanian, San Diego, CA (US); Mehmet Yavuz, Campbell, CA (US)

(21) Appl. No.: 18/678,965

(22) Filed: May 30, 2024

Related U.S. Application Data
(60) Provisional application No. 63/505,254, filed on May 31, 2023.

(51) Int. Cl. H04W 16/14; H04L 5/00; H04W 72/0453

(52) U.S. Cl. CPC H04W 16/14; H04L 5/0064; H04L 5/0073; H04W 72/0453

(57) ABSTRACT

A communication network comprising a plurality of CBSDs (Citizen Broadband Radio System Devices) and a Frequency Allocation System is disclosed. In some embodiments, the Frequency Allocation System includes a SON (self-organizing network). A SON, in accordance with the disclosed method and apparatus, organizes a network to have an outer and inner ring configuration of CBSDs that enhances strategic planning for the spectrum being allocated for use by the network. The use of this configuration may significantly minimize co-channel interference between several frequency bands, such as DoD (Department of Defense) frequency bands 3.1 to 3.4 GHz; CBRS frequency bands 3.55 to 3.7 GHz; and WiFi frequency bands 5 GHz and 6 GHz.

### CLAIM OF PRIORITY TO PREVIOUSLY FILED PROVISIONAL APPLICATION-INCORPORATION BY REFERENCE

This non-provisional application claims priority to an earlier-filed provisional application No. 63/505,254 filed May 31, 2023, entitled “Spectrum Controller To Assist Allocation Of Spectrum And Guaranteeing The Quality Of Service (QOS) Within The Enterprise Network” (ATTY DOCKET NO. CEL-076-PROV) and the provisional application No. 63/505,254 filed May 31, 2023, and all its contents, are hereby incorporated by reference herein as if set forth in full.

### BACKGROUND

### (1) Technical Field

The disclosed method and apparatus relate generally to communication networking. In particular, the disclosed method and apparatus relates to self-organizing networks in a communication network.

### (2) Background

SONs (Self-Organization Networks) are an important part of 5G networks. SONs allow automation to be used to improve network performance and efficiency, improve user experience and reduce operational expenses and complexity. A SON or an Interference management algorithm may decide the channel/frequency, bandwidth, and power limit to be used for transmitting over a network.

Having sufficient spectrum is crucial for 4G and 5G networks to operate successfully. The recent roll-out of CBRS (Citizen Band Radio Service) spectrum enables greater deployment of private networks. CBRS operates on a three-tier approach. The first tier (Tier 1) ensures that an incumbent user has priority for accessing the spectrum. The second tier (Tier 2) defines PAL (priority access license) users (i.e., those users that pay for access to the spectrum). The third tier (Tier 3), is for GAA (General Authorized Access) users (anyone, so long as there are no Tier 1 or Tier 2 users that might be adversely affected by the GAA users). The entire 150 MHz spectrum is free for all to use with the simple restriction that the GAA users must step aside for PAL and incumbent users.

Recently, MNOs (Mobile Network Operators) are gaining less access to the GAA spectrum due to incumbent users that have priority over the spectrum, PAL users and other GAA users that are all vying with one another for use of the spectrum. This makes it hard to acquire and maintain access to a clean and consistent channel for GAA users. In large part, this is due to there being more: (1) WiFi AP's (access points) on the CBRS band (e.g., entities like Comcast); (2) public cellular deployments on C-Band which can potentially add to adjacent channel interference; and (3) Enterprise (non-WiFi entity) deployments.

The above problem leads to difficulty in guaranteeing QoS, high throughput performance, low latency, etc. due to the fact that there is less bandwidth availability for each UE (user equipment) and by CBSDs (Citizen Broadband Radio System Devices).

Accordingly, it would be advantageous to provide a system that can manage the SON to provide efficient operation.

### SUMMARY

A communication network comprising a plurality of CBSDs (Citizen Broadband Radio System Devices) and a Frequency Allocation System is disclosed. In some embodiments, the Frequency Allocation System includes a SON (self-organizing network). A SON, in accordance with the disclosed method and apparatus, organizes a network to have an outer and inner ring configuration that enhances strategic planning for the spectrum being allocated for use by the network. The use of this configuration may significantly minimize co-channel interference between several frequency bands, such as DoD (Department of Defense) frequency bands 3.1 to 3.4 GHz; CBRS frequency bands 3.55 to 3.7 GHZ; and WiFi frequency bands 5 GHz and 6 GHz.

Based on the predicted nature of the traffic, a SON or a RIC (Real-time Intelligence Controller) decides what carrier aggregation or dual connectivity needs should be enabled on each of two different spectrum bands (for example two of the following frequency ranges: DoD-3.1 to 3.4 GHz; CBRS-3.55 to 3.7 GHZ; and WiFi-5 GHz).

In some embodiments, a coarser allocation of bandwidth for each AP (Access Point) and a wider bandwidth is allocated. Fine tuning of real-time allocation of the bandwidth is managed using BWP (Bandwidth Parts) load balancing based on real-time traffic demands. By having more inter-frequency deployment, there is less handover delay (e.g., in the order of 15 to 20 ms). This leads to improving both latency and performance in a HO (Handover) by managing intra and inter-frequency, wider and narrow bandwidth allocation for the individual AP's, BWP (Bandwidth Part) management, and SSB (Synchronization Signal Block) allocation to avoid interference.

Impact resulting from an adjacent channel C-band on the CBRS bands can be minimized by the SON (or RIC in more advanced networks), which carefully allocate the channels. In some embodiments, the choice of the technologies available in each location within a campus is determined based on the amount of support required for each application. In some embodiments, all of the available technologies are used to cover the full campus.

In accordance with some embodiments of the disclosed method and apparatus, the enterprise operator can still ensure performance in terms of Dynamic Protection Area (DPA), whisper zone, and Priority Access License (PAL) access.

Regarding service and demand-based RAN parameter configuration, a service consists of paging and access. This includes operation in the inactive state and connected mode operation with specific Quality of Service (QOS) parameterization. In accordance with the disclosed method and apparatus, depending on the load on the channel, the choice of primary/secondary channel or technology will be chosen for each box to the connected CPE/UE (Customer Provided Equipment/User Equipment) so the number of packets dropped can be minimized during handover in terms of Physical Random Access Channel (PRACH), Resource Block (RB) allocation, HO delay, missing of handover packets (measurement report on event A2 or A5 or A3 offset, RRC (Radio Resource Control) reconfiguration, HO request, etc.).

Bandwidth allocation for PCC (Primary Component Carrier) and SCCs (Secondary Component Carriers) is determined proportionally in a way that supports the service and traffic demands. Additionally, the appropriate choice of channel to be used as PCCs and SCCs for the individual UEs is determined based on the usage.

In some cases, higher demand use case applications, such as Augment Reality (AR)/Virtual Reality (VR), need to be supported. In some cases, a maximum potential of carrier aggregation (up to 8 carriers in 5G) is possible in some embodiments of the disclosed method and apparatus.

The disclosed method and apparatus provides a Spectrum Controller or SON that decides which RF to turn ON which piece of spectrum. A SAS (Spectrum Access System) provides spectrum allocation for CBRS (3.55 to 3.7 GHZ)—GAA on tier 3.

DoD (3.1 to 3.4 GHz) can potentially be operated in a two-tier approach for spectrum allocation. 802.11 5 GHz or 6 GHz (NR-U/WiFi) can operate with database coordination for spectrum or channel allocation, depending upon the range of the spectrum and nature of the deployment (indoor/outdoor). Millimeter (>20 GHz) is future unlicensed/licensed spectrum that is allocated based on the availability in each region.

### BRIEF DESCRIPTION OF THE DRAWINGS

The disclosed method and apparatus, in accordance with one or more various embodiments, is described with reference to the following figures. The drawings are provided for purposes of illustration only and merely depict examples of some embodiments of the disclosed method and apparatus. These drawings are provided to facilitate the reader's understanding of the disclosed method and apparatus. They should not be considered to limit the breadth, scope, or applicability of the claimed invention. It should be noted that for clarity and ease of illustration these drawings are not necessarily made to scale.

FIG. 1 illustrates an embodiment of the disclosed method and apparatus using outer and inner ring spectrum allocation.

FIG. 2 illustrates CBSD/DoD spectrum allocated to a CBSD in the outer ring and to a CBSD in the inner ring.

FIG. 3 is a flowchart showing the method for allocating spectrum.

FIG. 4 is a flowchart showing the CBRS outer and inner ring allocation.

FIG. 5 is a flowchart showing the process of allocating WiFi spectrum.

FIG. 6 is an illustration of one example of a call flow showing the sequence of messages that pass between a CBSD and the Spectrum Controller with respect to spectrum access in CBRS, DoD and WiFi frequency bands.

FIG. 7 provides one example of a Frequency Allocation System comprising a general purpose processor that can perform all of the functions of the Frequency Allocation System.

The figures are not intended to be exhaustive or to limit the claimed invention to the precise form disclosed. It should be understood that the disclosed method and apparatus can be practiced with modification and alteration, and that the invention should be limited only by the claims and the equivalents thereof.

### DETAILED DESCRIPTION

### Spectrum Allocation Modes

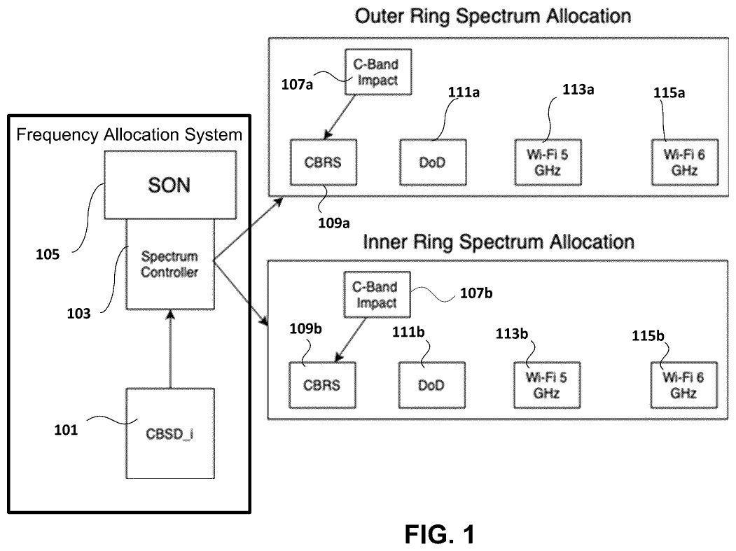

FIG. 1 illustrates an embodiment of the disclosed method and apparatus using outer and inner ring spectrum allocation for use by CBSDs (Citizen Broadband Radio System Devices) 101. A CBSD 101 is a user operated transmitter access point that operates in the Citizens Broadband Radio Service (CBRS) spectrum. For the purpose of this document, CBRS spectrum includes spectrum at 3.55 to 3.7 GHZ, as well as frequencies at 3.1 to 3.4 GHz (which are commonly used by U.S. Department of Defense, and frequencies in 5 to 6 GHz (commonly used for WiFi communications that adhere to the well-known 802.11 industry specification). In some embodiments, CBRS frequencies also include millimeter frequencies laying above 20 GHz.

In accordance with some embodiments of the presently disclosed method and apparatus, a Spectrum Controller 103 will have information about the traffic or spectrum demand for each CBSD regarding CBRS, DoD (Dept. of Defense), and WiFi spectrum. Based on demand for spectrum and services, the assignment of RF spectrum and determination of power levels are optimized.

A SON (Self-Organization Network) 105 enables automation to improve network performance and efficiency, improve the user experience and reduce operational expenses and complexity. The SON 105 decides the channel/frequency, bandwidth, and power limit.

CBRS channels 109a and 109b at frequencies of 3.55 to 3.7 GHz are denoted by α={α_1, α_2, . . . , α_n} and the total available channel based on the location and SAS assessment is denoted by sum (a).

DoD channels 111a and 111b at frequencies of 3.1 to 3.4 GHz are denoted by β={β_1, β_2, . . . , β_n} and the total available channel based on the location, calendar-based look-up table or informing the incumbent, and is denoted by sum (β).

WiFi channels 113a, 115a, 113b and 115b on 5 GHz or NR-U 6 GHz are denoted by γ={γ_1, γ_2, . . . , γ_n} and the total available channel based on the location (i.e., AFC data-base and average energy detection threshold per channel) is denoted by sum (γ).

### Spectrum Allocation Modes

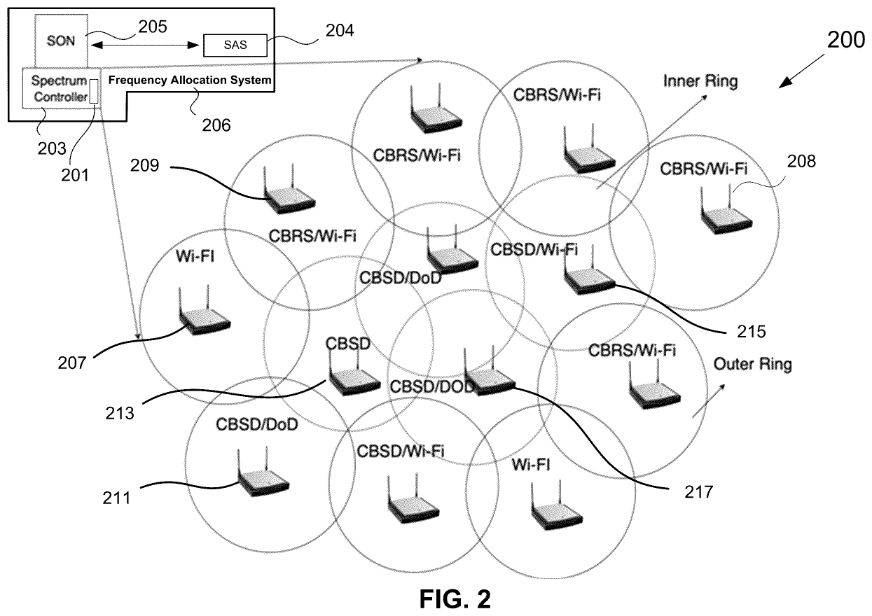

FIG. 2 illustrates a network deployment of an enterprise network in which some CBSDs 207, 209, 211 are physically located in an outer ring and other CBSDs 213, 215, 217 are physically located in an inner ring. In some embodiments, frequency is allocated to CBSDs 207, 209, 211 by a processor within the Frequency Allocation System 206. In some embodiments, the Frequency Allocation System 206 comprises a Spectrum Controller 203, a SAS 204 and a SON 205, one or more of which have a processor for determining the allocation of spectrum to those CBSDs 207, 209, 211 that physically reside in the outer ring and those CBSDs 213, 215, 217 that physically reside in the inner ring. Initially, the SAS 204 indicates to the SON 205 which frequencies are available for the SON 205 and Spectrum Controller 203 to allocate to the various CBSDs 207, 209, 211, 213, 215, 217 of the network 200. However, it will be clear to those skilled in the art that the functions of the Frequency Allocation System 206 can be performed by devices that do not necessarily perform all of the functions associated with a Spectrum Controller, SAS and/or SON. That is, while the functions related to the presently disclosed method and apparatus are described herein as being performed by a Spectrum Controller 203, the SAS 204 and the SON 205 within the Frequency Allocation System 206, the relevant functions of determining how to allocate frequencies to the various CBSDs disclosed herein can be performed by a Frequency Allocation System 206 comprising one or more devices that may perform the some, all, or none of the functions associated with a Spectrum Controller 203, SAS 204 and SON 205 that are not related to the presently disclosed method and apparatus.

In some embodiments of the disclosed method and apparatus, the frequency allocation is calculated based on an initial coverage plan. In one example, the enterprise network 200 is deployed in a factory. The enterprise network 200 allows both factory machines, robotic delivery devices, desktop computers and hand held communication devices (e.g., tablets and cellphones) to connected to one another and to the internet through the CBSDs 207, 209, 211, 213, 215, 217 of the deployed enterprise network 200. By configuring the CBSDs in an outer ring of CBSDs 207, 209, 211 and an inner ring of CBSDs 2013, 215, 217, the CBSDs 213, 215, 217 in the inner ring are buffered from external interference by the CBSDs 207, 209, 211 of the outer ring (i.e., the outer ring of CBSDs place physical space between the CBSDs of the inner ring and any source of interference that lies physically outside the space in which the deployed enterprise network resides).

In some embodiments, frequency allocated to each CBSD 207, 209, 211, 213, 215, 217 may vary dynamically based on interference. Such interference may come, for example, from a Mobile Network Operator (MNO) operating at frequencies that negatively impact the operation of at least some of the CBSDs. Several spectrum allocation modes are possible.

In the embodiment shown in FIG. 2, at one particular point in time, two CBSDs 207a, 207b are allocated spectrum in the WiFi operating range of 5 to 6 GHz. Another six CBSDs 209 operate in both the WiFi operating range and in the CBRS operating range of 3.55 to 3.7 GHz. In addition, there is one CBSD 211 in the outer ring that is allocated spectrum in the DoD frequencies of 3.1 to 3.4 GHz. Another CBSD 213 residing in the inner ring is allocated spectrum in the CBSD range of 3.55 to 3.7, yet another CBSD 215 is allocated spectrum in both CBRS range 3.55 to 3.7 GHZ and WiFi frequencies of 5 to 6 GHz, and yet another two CBSDs 217 in the inner ring allocated spectrum in both CBRS range 3.55 to 3.7 GHZ and DoD frequencies of 3.1 to 3.4 GHz.

Based on the interference and load, frequencies in the DoD frequency range, CBRS frequency range of 3.55 to 3.7 and in the WiFi range of 5 to 6 GHz can be allocated to any of the CBSDs that reside in either the outer, inner ring or in both the outer and inner rings. The choice of carrier aggregation and/or dual connectivity (i.e., use of non-contiguous frequency ranges) is enabled in terms of the primary and secondary component carriers. Accordingly, each CBSD is capable of operating in all of the technologies (i.e., DoD, CBRS and WiFi).

### Spectrum Allocation Demand Calculation Algorithm for Each CBSD

In accordance with the disclosed method and apparatus, each CBSD is capable of operating on any of the available ranges of spectrum, such as low (<1 GHZ), mid (1 to 6 GHz) and high (>6 GHz).

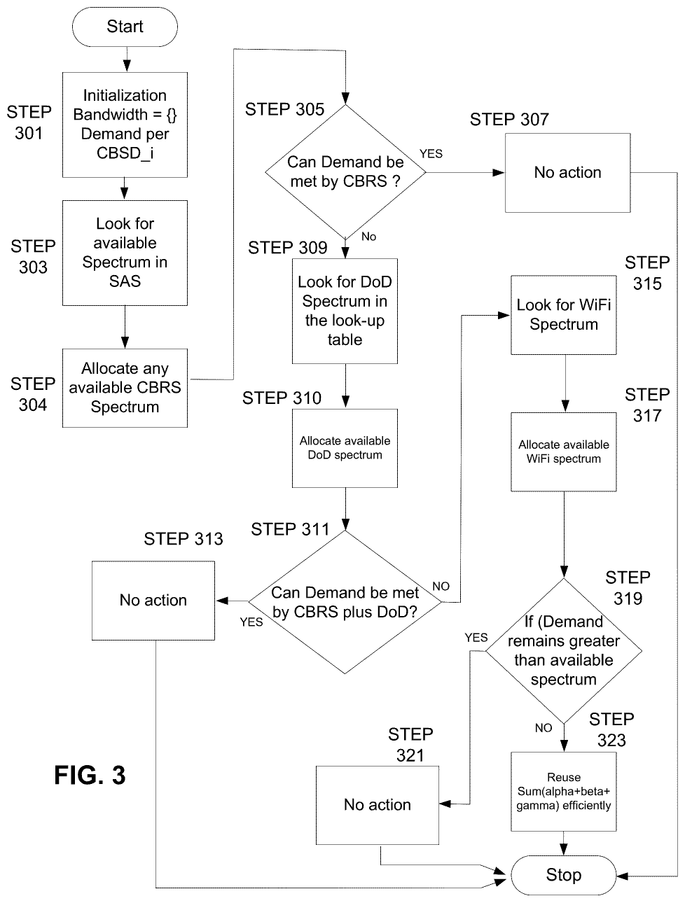

FIG. 3 is a flowchart showing the method for allocating spectrum. In a first process loop performed by a processor within the Frequency Allocation System 206, no pre-assignment is made (i.e., the Bandwidth={ }, an empty set), such that initially the Spectrum Controller 103 or SON 105 starts with no allocation prior to each CBSD 207, 209, 211, 213, 215, 217 turning ON its RF (STEP 301).

Once the RF is turned ON, the determination is made as to what spectrum in the 3.55 to 3.7 GHz range (i.e., CBRS frequencies) has been provided to the network 200 by the SAS 204 (STEP 303). All such spectrum is allocated by the SON 205 and the Spectrum Controller 203 to the CBSDs 207, 209, 211, 213, 215, 217 to support the network users (STEP 304). This allocation is communicated from a transceiver 201 within the Frequency Allocation System 206 to transceivers 208 in each of the CBSDs 207, 209, 211, 213, 215, 217. In some embodiments, the transceiver 201 of the Frequency Allocation System 206 resides in the Spectrum Controller 203.

Next, a determination is made as to whether that allocation in the 3.55 to 3.7 GHZ range is sufficient to support the demand placed on the network by the users of the network 200 (STEP 305). In accordance with some embodiments, the demand that is likely to be placed upon each CBSD 207, 209, 211, 213, 215, 217 is determined based on the number of RBs (resource blocks) that are required to be transmitted over the initial allocation of spectrum, which depends upon the GBR (guaranteed bit rate) and N-GBR (non-guaranteed bit rate). In some embodiments, the amount of latency present when servicing current requests over the network 200 by users of the network 200 is used as an indication of whether the current spectrum allocation is providing sufficient support to meet the demand being placed on the network resources (i.e., whether there is sufficient bandwidth allocated to the network). That is, if latency through any particular CBSD is relatively high, it may be necessary to allocate more spectrum to that CBSD to reduce the latency and ensure that all users are serviced in a manner that provides an acceptable quality of service. If the initial allocation provided by the SAS 204 and implement by the SON 205 and the Spectrum Controller 203 is sufficient to service all of the CBSDs 207, 209, 211, 213, 215, 217, then no action is taken in the Spectrum Controller 103 and the first process loop is complete (STEP 307).

If, however, the demand for spectrum is greater than the initial allocation (e.g., the total number of RBs is greater than the current allocation of spectrum can support) (STEP 305), additional clean spectrum is sought from the DoD spectrum (STEP 309). In particular a second process loop is implemented in which DoD spectrum is sought. In some embodiments, such DoD spectrum is sought by looking in the calendar look-up table. The calendar look-up table is a guide that indicates when particular DoD users are scheduled to use spectrum in the geographic area near the enterprise network. Any available DoD spectrum is then allocated (STEP 310).

Next, a determination is made as to whether the available CBRS in the frequency range of 3.55 to 3.7 GHZ, taken together with the DoD spectrum is sufficient to satisfy the demands placed on the network 200 (STEP 311). If so, no further action is required of the Spectrum Controller 103 and the second process loop is complete (STEP 313).

If the available CBRS in the frequency range of 3.55 to 3.7 GHZ, taken together with the DoD spectrum is not sufficient to satisfy the demands placed on the network 200 (STEP 311), then WiFi spectrum is sought (STEP 315). Any available WiFi spectrum on 5 and 6 GHz is then allocated to increase the capability of the network 200 (STEP 317). The total capacity of the network 200 is then checked (e.g., by checking the latency of the responses to requests made through each of the CBSDs 207, 209, 211, 213, 215, 217, for example) to determine whether there is sufficient spectrum available (STEP 319) after allocating the additional WiFi spectrum. If the allocation of spectrum to the network 200 is now sufficient to support all of the demand placed on the network 200, the third process loop is complete, and no further action is required (STEP 321).

If, on the other hand, the allocation of spectrum to the network 200 is still insufficient to support all of the demand placed on the network 200 (STEP 319), the CBRS, DoD, and WiFi spectrum are efficiently reused (STEP 323). This is done by allocating the transmit power to each CBSD 207, 209, 211, 213, 215, 217 in a manner that reduces the co-channel interference between CBSDs that are allocated common frequency spectrum. Such reuse is implemented to ensure that the overall performance (latency and throughput) of the network 200 is provided.

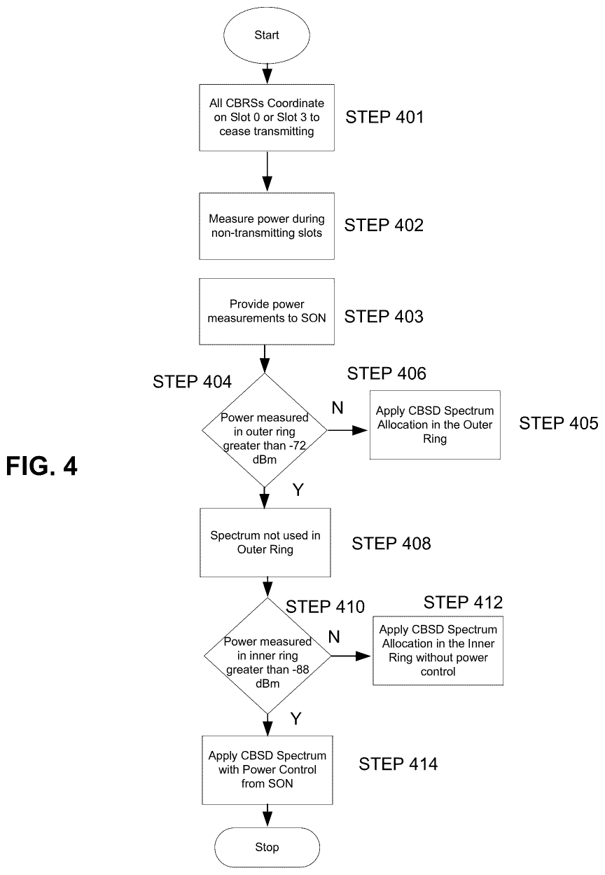

FIG. 4 is a flowchart showing the CBRS outer and inner ring allocation of spectrum in the 3.55 to 3.7 GHz frequency range. Upon starting the process, the SON 205 (or the RIC for more advanced networks) coordinates all of the CBSDs 207, 209, 211, 213, 215, 217 to cease transmitting during a selected time slot (STEP 401), (e.g., slot 0 or slot 3 within the frame structure) to allow power emanating from non-network sources to be measured (STEP 402) without the network CBSDs 207, 209, 211, 213, 215, 217 adding to the power present in the medium (i.e., in the channel). Power measurements of the 3.55 to 3.7 GHz frequency spectrum are provided to the SON 205 (STEP 403). The time interval between such measurements can be variable, with an initial interval being set based on estimates of the environmental conditions, but with the intervals then being informed by measurements that are made over time. Accordingly, if over time, measurements indicate that there are periods of the day, week, month, etc. during which conditions are more likely to change, measurements can be taken at shorter intervals during such periods of more rapid change. Likewise, if there are periods during which the environment is not likely to change, measurements will be requested less frequently.

In some embodiments, all of the CBSDs and other network equipment are capable of operating on CBRS, DoD, and WiFi frequencies. In some embodiments, the amount of power that is detectable by a receiver is measured for each of these frequency bands. In some such embodiments, such power measurements are made by one or more of the CBSDs. In other embodiments, one or more independent measuring devices deployed in the network provide measurements of the power levels within the frequencies of interest (e.g., CBRS, DoD and WiFi frequency ranges). If the average in-band power measured by the CBSDs of the outer ring (or a measuring device within the outer ring and capable of communicating the measurements to the Frequency Allocation System) is less than-72 dBm (STEP 404) for the frequency range of 3.55 to 3.7 GHz, it is determined that the amount of interference is tolerable in the outer ring to allow allocation of spectrum in the 3.55 to 3.7 GHz range. Accordingly, this frequency range can be allocated to CBSDs of the outer ring (STEP 406). If, however, the amount of power measured in the frequency range of 3.55 to 3.7 GHz is greater than-72 dBm, then the Spectrum Controller 203 does not allocate spectrum in that frequency range to the CBSDS of the outer ring (STEP 408).

Next, a determination is made as to whether the average power in the frequency range of 3.55 to 3.7 GHZ measured by CBSDs in the inner ring (or a measuring device deployed in the inner ring and capable of communicating the measurements to the Frequency Allocation System) is greater than-88 dBm (STEP 410). If not (i.e., if less than-88 dBm), then spectrum is allocated to CBSDs the inner ring without power control (STEP 412). Otherwise, spectrum is allocated in frequency range of 3.55 to 3.7 GHz to CBSDs in the inner ring, but with power control. In some embodiments, such power control is provided by the SON 205 (STEP 414). Alternatively, other components of the Frequency Allocation System can provide such power control. By providing power control, the amount of power to be transmitted by each of the CBSDs can be adjusted to ensure that the signal can be reliably transmitted and received by each CBSD.

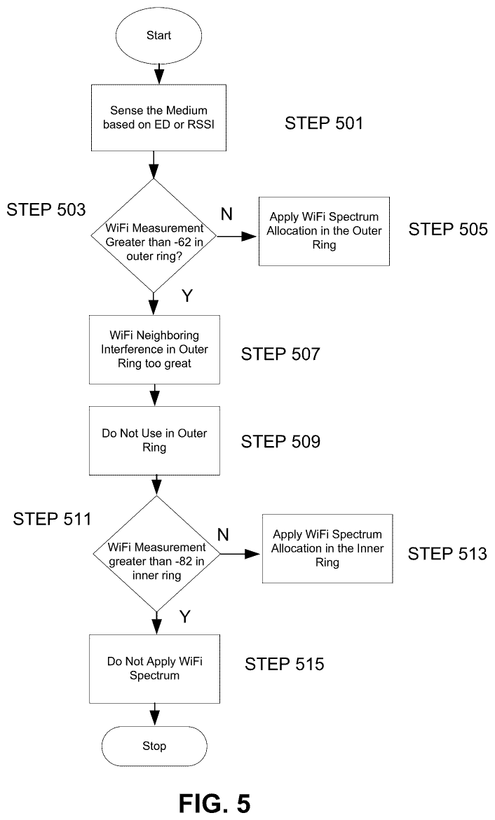

FIG. 5 is a flowchart showing the process of allocating WiFi spectrum. It should be noted that spectrum in the range of 3.55 to 3.7 GHz has issues that differ from spectrum in the WiFi frequency range of either 5 GHz or 6 GHz.

Initially, the process begins with sensing and measuring the unlicensed medium (i.e., the frequencies in the 5 and 6 GHz range that have been generally designated for use for WiFi communications). These measurements are made to determine the load and interference on the WiFi network (STEP 501). In some embodiments, these measurements are made by a receiver within the CBSDs of the network. Alternatively, these measurements are made by sensors that are independent of the CBSDs. The measurements can be made as RSSI (Received Signal Strength Indicator) or ED (Energy Detection) measurements. If the average power measured in the WiFi frequency range by CBSDs in the outer ring is not greater than a first threshold level, such as −62 dBm (STEP 503), then additional allocations of spectrum in this frequency range are made to augment the spectrum available for use by CBSDs of the network (STEP 505). Otherwise, WiFi interference in the outer ring is too great (STEP 507), and so no allocation is made to CBSDs operating in the outer ring (STEP 509).

If the average power measured in the WiFi frequency range by CBSDs residing in the inner ring is not greater than-82 dBm (STEP 511), then additional allocations of spectrum are made for CBSDs residing in the inner ring (STEP 513). However, if the interference is too great, as indicated by measuring more than-82 dBm of power in the WiFi frequencies, then no additional WiFi spectrum is allocated to those CBSDs in the inner ring (STEP 515).

Two approaches are disclosed herein for allocating DoD spectrum. A first approach uses a date, time, frequency and channel number, for example, to check a calendar look-up table for free spectrum (i.e., spectrum that is not previously scheduled for use by a US DoD agent. Allocation of spectrum is then made based on the information retrieved from the look-up table.

In a second approach, the DoD system informs the 4G or 5G radio regarding operation on frequencies of 3.1 to 3.4 GHz.

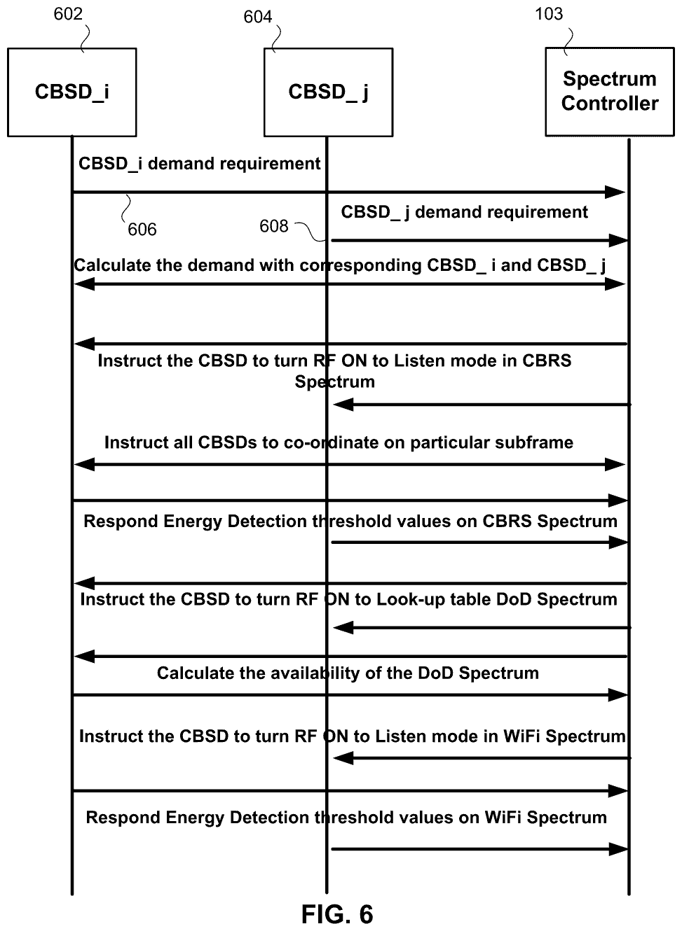

FIG. 6 is an illustration of one example of a call flow showing the sequence of messages that pass between a CBSD 602, 604 and the Spectrum Controller 103 with respect to spectrum access in CBRS, DoD and WiFi frequency bands.

Initially, each CBSD 602, 604 sends a message 606, 608 to the Spectrum Controller 103 with the “demand requirements” indicating the amount of spectrum (or otherwise indicating the amount of resource) required. The Spectrum Controller 103 calculates the requirements for each CBSD in terms of spectrum, based on the total number of connected devices, the average latency, and the application performance. Next, the Spectrum Controller 103 controls transmissions of the CBSDs to gain information regarding the CBRS spectrum by sensing the medium in a coordinated fashion to avoid any false detection on the channel.

The Spectrum Controller 103 also determines the DoD spectrum by sensing the medium on the coordinated fashion to avoid any false detection on the channel.

Lastly, the Spectrum Controller determines the WiFi spectrum by sensing the medium based on the carrier sense multiple access (CSMA) protocol.

The disclosed method and apparatus has at least the following advantages: (1) providing more availability of spectrum to ensure or guarantee the QoS or offload to the available spectrum in which the CPEs/UEs are connected; (2) the different footprint of frequency has the advantage in terms of coverage (low frequency) and capacity (more spectrum); (3) the allocation of the spectrum on different bands of WiFi/DoD reduces the possibility of more co-channel interference on GAA allocation within and neighboring operators; (4) the efficient planning leads to less number of the box to be deployed in the warehouse, ports, etc. that in turn reduce the cost of BS (base stations) and the cost of the spectrum (for example the cost involved in CBRS spectrum/SAS); (5) L1 and L2 overflow, and delay in the prioritized users/traffic, can be minimized in this proposal; (5) easier planning of the network for RF coverage knowing footprint availability of the multiple technologies; (7) the coverage hole and blockage to penetration of signal of induvial technologies become less of an issue; and (8) the CPE/UE power consumption can be minimized if the sleep duration of the receiver is higher due to more allocation of RBs to satisfy the QoS requirement.

Although the disclosed method and apparatus is described above in terms of various examples of embodiments and implementations, it should be understood that the particular features, aspects and functionality described in one or more of the individual embodiments are not limited in their applicability to the particular embodiment with which they are described. For example, while the Frequency Allocation System is shown in one embodiment as comprising a SON, SAS and Spectrum Controller, the Frequency Allocation System may be a single device that performs all of the functions of the SON, SAS and Spectrum Controller, or alternatively, a plurality of devices that distribute the functions noted in this disclosure in a manner other than the manner in which the disclosed functions are shown to be distributed among the SON, SAS and Spectrum Controller.

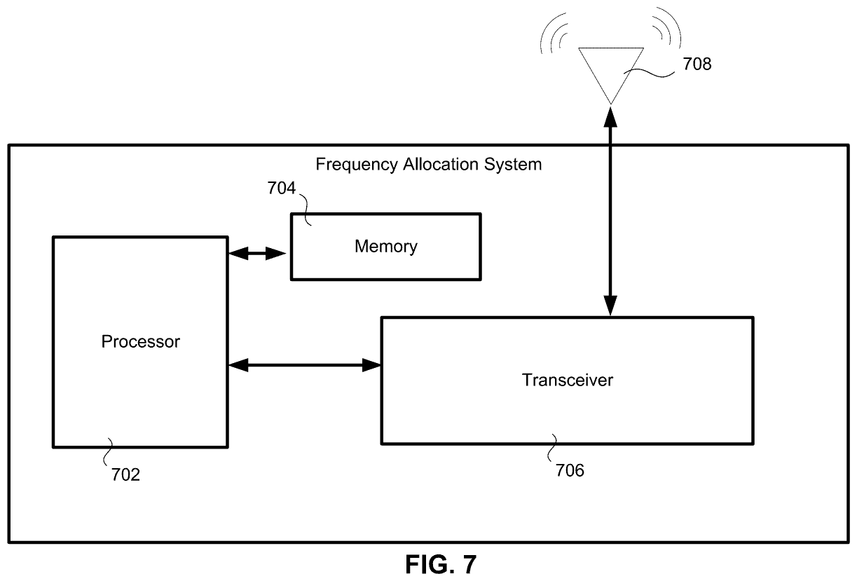

FIG. 7 provides one example of a Frequency Allocation System 700 comprising a general purpose processor 702 that can perform all of the functions of the Frequency Allocation System disclosed above. The general purpose processor 702 is coupled to a memory 704 capable of storing instructions that can be read and executed by the general purpose processor 702 in order to perform the disclosed functions. A transceiver 706 is also coupled to the general purpose processor 702 to allow the general purpose processor 702 to communicate with the CBSDs of the network through an antenna 708.

Thus, the breadth and scope of the claimed invention should not be limited by any of the examples provided in describing the above disclosed embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide examples of instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the disclosed method and apparatus may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described with the aid of block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A communication network comprising:
a) plurality of CBSDs (Citizen Broadband Radio System Devices), each having a transceiver; and
b) a Frequency Allocation System comprising:
i) a transceiver configured to communicate with the transceivers of the CBSDs;
ii) a processor module configured to:
A) determine a frequency allocation of frequency in the CBRS band;
B) determine whether the frequency allocation in the CBRS band is sufficient to meet the demand of the CBSDs;
C) determine what Department of Defense (DoD) frequencies are available;
D) determine whether the amount of available CBRS plus available DoD frequencies are sufficient to meet the demand of the CBSDs;
E) determine what WiFi frequencies are available;
F) determine whether the available CBRS plus available DoD plus available WiFi frequencies are sufficient to meet the demand of CBSDs;
wherein the processor allocates only CBRS frequencies for use by the CBSDs if the available CBRS frequencies are sufficient to meet the demands of all of the CBSDs and the processor allocates only CBRS and DoD frequencies if the CBRS frequencies are not sufficient to meet the demands of the CBSDs, and further, wherein the processor allocates CBRS, DoD and WiFi frequencies if the CBRS and DoD frequencies are insufficient to meet the demands of the CBSDs, and wherein the transceiver communicates the frequency allocation to the CBSDs.

2. A communication network comprising:
a) a first plurality of CBSDs (Citizen Broadband Radio System Devices) of an inner ring, each having a transceiver;
b) a second plurality of CBSDs of an outer ring, each having a transceiver; and
c) a frequency Allocation System comprising:
i) a transceiver configured to communicate with the transceivers of the CBSDs; and
ii) a processor module configured to;
A) receive measurements indicating signal strength of signals near CBSDs of the inner ring and CBSDs of the outer ring;
B) allocating WiFi frequencies for use by CBSDs in the outer ring only if measurements near CBSDs in the outer ring are less than a first threshold level; and
C) allocating WiFi frequencies for use by CBSDs in the inner ring only if less than a second threshold, the second threshold being less than the first threshold.

3. The communication network of claim 2, wherein the processor module is further configured to allocate DoD (Department of Defense) frequencies, the processor module configured to receive date, time, frequency and channel number information indicating when a US DoD agent is likely to use particular frequencies and to allocate such DoD frequencies for use by CBSDs based on the received information.

4. The communication network of claim 2, wherein the processor module is further configured to receive communications directly from the DoD including usage information regarding use of DoD frequencies and to allocate such DoD frequencies to CBSDs based on the received usage information.

5. A method for allocating frequencies for use by a communication network, the method comprising:
a) determining within a frequency Allocation System, a frequency allocation of frequency in the CBRS band, the determination including;
i) determining whether the frequency allocation in a CBRS band is sufficient to meet the demand of CBSDs within the communication network;
ii) determining what Department of Defense (DoD) frequencies are available for use by CBSDs of the communication network;
iii) determining whether the amount of available CBRS plus available DoD frequencies are sufficient to meet the demand of the CBSDs of the communication network;
iv) determining what WiFi frequencies are available to be used by the CBSDs of the communication network;
v) determining whether the available CBRS plus available DoD plus available WiFi frequencies are sufficient to meet the demands placed on the CBSDs of the communication network;
vi) allocating only CBRS frequencies for use by the CBSDs if the available CBRS frequencies are sufficient to meet the demands of all of the CBSDs;
vii) allocating only CBRS and DoD frequencies if the CBRS frequencies are not sufficient to meet the demands of the CBSDs;
viii) allocating CBRS, DoD and WiFi frequencies if the CBRS and DoD frequencies are insufficient to meet the demands of the CBSDs; and
ix) communicating the frequency allocation to the CBSDs.

6. A method for allocating frequencies to CBSDs (Citizen Broadband Radio System Devices) of a communication network, the method comprising:
a) deploying a first plurality of CBSDs (Citizen Broadband Radio System Devices) within an inner ring;
b) deploying a second plurality of CBSDs to an outer ring
c) receiving measurements indicating signal strength of signals near CBSDs of the inner ring and CBSDs of the outer ring;
d) allocating WiFi frequencies for use by CBSDs in the outer ring only if measurements near CBSDs in the outer ring are less than a first threshold level; and
e) allocating WiFi frequencies for use by CBSDs in the inner ring only if less than a second threshold, the second threshold being less than the first threshold.
